(19) United States
(12) Patent Application Publication
(10) Pub. No.: US 2025/0011639 A1
(43) Pub. Date: Jan. 9, 2025

(54) CORROSION INHIBITOR HAVING CARBON-BASED NANOPARTICLES

(71) Applicant: ChampionX LLC, Sugar Land, TX (US)

(72) Inventor: Jeremy Moloney, Katy, TX (US)

(21) Appl. No.: 18/758,086

(22) Filed: Jun. 28, 2024

Related U.S. Application Data
(60) Provisional application No. 63/511,385, filed on Jun. 30, 2023.

(51) Int. Cl. C09K 8/54

(52) U.S. Cl. CPC C09K 8/54; C09K 2208/10; C09K 2208/32

(57) ABSTRACT

Corrosion inhibitor compositions that include carbon-based nanoparticles, one or more corrosion inhibitor compounds, and one or more solvents. A method includes contacting a fluid comprising the corrosion inhibitor composition with a metal surface to inhibit corrosion on the metal surface.

### CROSS-REFERENCE TO RELATED APPLICATION

This application is a non-provisional patent application claiming the benefit of, and priority to, U.S. Provisional Patent Application No. 63/511,385, filed Jun. 30, 2023, which is incorporated by reference herein in its entirety.

### FIELD OF THE DISCLOSURE

The present disclosure generally relates to corrosion inhibitor compositions.

### BACKGROUND

Oil and gas production infrastructure can include equipment (e.g., pipelines, flow lines, valves, separation equipment) that is constructed of mild carbon steel. The internal metal surfaces of the equipment are subject to corrosion, particularly for production fluid that has a high concentration of water and/or corrosive agents. Contact of the internal metal surfaces with water and/or corrosive agents can lead to corrosion, and even equipment failure. The rate of corrosion deterioration in oil and gas field equipment can depend upon production parameters such as oil/water ratio, brine composition, temperature, pH, and the concentration of corrosive agents that are present in the subterranean formation, such as CO₂ and H₂S.

In order to preserve the integrity of oil and gas infrastructure, corrosion inhibitors can be added into the production fluid upstream of the equipment that is to be protected. For example, corrosion inhibitors can protect the metal surface of pipeline and/or equipment through formation of a passivation film on the metal surface. This passivation layer oil wets the metal surface, which in turn prevents contact of the metal surface from the corrosive agents in the produced fluids.

Despite the availability of corrosion inhibitor formulations, there is ongoing effort to find improved compounds, compositions, and methods.

### SUMMARY

Disclosed are corrosion inhibitor compositions that can include carbon-based nanoparticles, one or more corrosion inhibitor compounds, and one or more solvents.

Also disclosed are methods for inhibiting corrosion of a metal surface used to contain or convey a fluid. One method can include contacting a fluid comprising the corrosion inhibitor composition as disclosed herein with the metal surface. Another method can additionally or alternatively include adding, introducing, or injecting the corrosion inhibitor composition into the fluid prior to or during contact of the fluid with the metal surface. Another method can additionally or alternatively include coating the metal surface with the corrosion inhibitor composition.

Other technical features may be readily apparent to one skilled in the art from the following descriptions and claims.

### DETAILED DESCRIPTION

The term “alkyl,” as used herein, refers to a linear or branched hydrocarbon radical, e.g., having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyl groups include, but are not limited to, methyl, ethyl, n-propyl, isopropyl, n-butyl, iso-butyl, secondary-butyl, and tertiary-butyl. Alkyl groups may be unsubstituted or substituted by one or more suitable substituents.

The term “aryl,” as used herein, means monocyclic, bicyclic, or tricyclic aromatic radicals such as phenyl, naphthyl, tetrahydronaphthyl, indanyl and the like; optionally substituted by one or more suitable substituents, e.g., 1 to 5 suitable substituents.

The term “arylalkyl,” as used herein, refers to an aryl group attached to the parent molecular moiety through an alkyl group. Arylalkyl groups may be unsubstituted or substituted by one or more suitable substituents.

The term “alkoxy,” as used herein, refers to an alkyl group, as defined herein, appended to the parent molecular moiety through an oxygen atom.

The term “hydroxy,” as used herein, refers to an —OH group.

As used herein, any recited ranges of values contemplate all values within the range including the end points of the range, and are to be construed as support for claims reciting any sub-ranges having endpoints which are real number values within the recited range. By way of example, a disclosure in this specification of a range of from 10 to 15 shall be considered to support claims to values of 10, 11, 12, 13, 14, and 15, and to any of the following ranges: 10-11, 10-12, 10-13, 10-14, 10-15, 11-12, 11-13, 11-14, 11-15, 12-13; 12-14, 12-15, 13-14, 13-15, and 14-15.

Disclosed herein are corrosion inhibitor compositions and methods for inhibiting corrosion.

### Corrosion Inhibitor Composition

The corrosion inhibitor compositions generally include carbon-based nanoparticles, one or more corrosion inhibitor compounds, and one or more solvents. The carbon-based nanoparticles are generally present in the corrosion inhibitors in an effective amount for corrosion inhibition as disclosed herein. The compositions can additionally include any additional component described herein.

It has been found that combining carbon-based nanoparticles with corrosion inhibitor compounds disclosed herein, and for use of the same in methods for inhibiting corrosion, increases corrosion inhibition performance in comparison to corrosion inhibitor compositions not having the carbon-based nanoparticles.

### Carbon-Based Nanoparticles

In some aspects, the carbon-based nanoparticles can be carbon nanotubes, carbon dots, carbon quantum dots, graphene, graphene quantum dots, graphene oxide, or combination thereof. Carbon-based nanoparticles are available commercially from Nanografi Nano Technology (including quantum dots and nanoplatelets), ACS Material LLC, Cheap Tubes Inc., SkySpring Nanomaterials, Inc, Nanolntegris Technology, Inc. (under the tradename PureWave™), Nanografi Nano Technology, Dotz Nano Ltd (including quantum dots), and 2D Materials Pte Ltd (under the tradename XP Graphene).

The carbon-based nanoparticles have at least one dimension that is from 1 nm to less than 1,000 nm; alternatively, 1 nm to 900 nm; alternatively, 1 nm to 800 nm; alternatively, 1 nm to 700 nm; alternatively, 1 nm to 600 nm; alternatively, from 1 nm to 400 nm; alternatively, 1 nm to 300 nm; alternatively, 1 nm to 250 nm; alternatively, 1 nm to 100 nm; alternatively, 200 nm to 500 nm; alternatively, 200 nm to 400 nm; alternatively, 300 nm to 400 nm; alternatively, from 30 nm to 100 nm; alternatively, from 50 nm to 100 nm; alternatively, from 1 nm to 50 nm; alternatively, from 1 nm to 40 nm; alternatively, from 1 nm to 30 nm alternatively, 2 nm to 20 nm. The carbon-based nanoparticles may assume a variety of geometries, such as spheres, hollow shells, rods, plates, sheets, dots, ribbons, prisms, stars, or combinations thereof. All geometries of nanoparticles are understood to be within the scope of this disclosure. For example, a particle (that is carbon-based) of 2 μm length and 10 nm diameter would be considered a “carbon-based nanoparticle” even though one of its dimensions is larger than the largest dimension generally accepted for nanoparticles, i.e., 500 nm. In another example, a rod of 10 nm diameter and 5 μm length would be considered a nanoparticle (a rod-like nanoparticle, or nanorod). One particular type of carbon-based nanoparticle is graphene quantum dots or graphene oxide quantum dots. Graphene (graphene oxide) quantum dots are comprised of a portion of a sheet of graphene (graphene oxide) of one or a few layers thick and have at least one dimension of from 1 nm to 100 nm; alternatively, from 12 nm to 27 nm; alternatively, from 2 nm to 10 nm; alternatively, from 1 nm to less than 5 nm; alternatively, from 1 nm to 2 nm. They typically having a lateral dimension of less than 10 mm.

In aspects, the at least one dimension is a diameter or approximate diameter of the carbon-based nanoparticles. The size of the carbon-based nanoparticles can be obtained by measuring the diameter or approximate diameter. For a population of nanoparticles, the diameter or approximate diameter can also be referred to as a Z-average particle size, which can be measured according to routine protocols known to one skilled in the art, for example, dynamic light scattering (DLS) (Z-average). Particle size can also be measured by Transmission Electron Microscopy (TEM).

In some aspects, the carbon-based nanoparticles are not bonded (e.g., covalently bonded) to a compound. In some aspects, the carbon-based nanoparticles have not previously been subjected to a chemical reaction(s) resulting in the presence of covalent bonds being formed between a corrosion inhibitor compound and a carbon-based nanoparticle. In some aspects, the carbon-based nanoparticles are not bonded to any corrosion inhibitor compound in the composition and do not react with any corrosion inhibitor compound in the composition.

### Corrosion Inhibitor Compounds

The one or more corrosion inhibitor compounds can include, but is not limited to, one or more imidazoline compounds or derivatives thereof, one or more quaternary ammonium compounds, one or more organic sulfur compounds, one or more phosphate esters, one or more monomeric or oligomeric fatty acids, one or more alkoxylated amines, or combinations thereof.

### Imidazoline Compounds

In aspects, the one or more of the corrosion inhibitor compounds can be an imidazoline derived from a diamine and a long chain fatty acid.

In aspects, the imidazoline can be an imidazoline of Formula (I) or an imidazoline derivative (such as an imidazolinium compound). Representative imidazoline derivatives include an imidazolinium compound of Formula (II) or a bis-quaternized imidazole derivative of Formula (III).

The one or more of the corrosion inhibitor compounds can comprise an imidazoline of Formula (I):

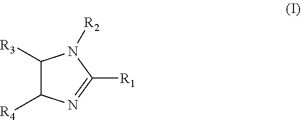

wherein R₁ is a C₁-C₂₀ alkyl or a C₁-C₂₀ alkoxyalkyl group; R₂ is hydrogen, C₁-C₆ alkyl, C₁-C₆ hydroxyalkyl, or C₁-C₆ arylalkyl; and R₃ and R₄ are independently hydrogen or a C₁-C₆ alkyl group. In aspects, the imidazoline includes an R¹⁰ which is the alkyl mixture typical in tall oil fatty acid (TOFA), and R¹¹, R¹² and R¹³ are each hydrogen.

The one or more of the corrosion inhibitor compounds can include an imidazolinium derivative of Formula (II):

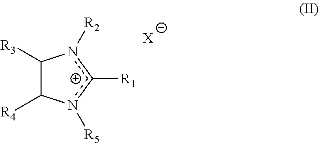

wherein R₁ is a C₁-C₂₀ alkyl or a C₁-C₂₀ alkoxyalkyl group; R₂ and R₅ are independently hydrogen, C₁-C₆ alkyl, C₁-C₆ hydroxyalkyl, or C₁-C₆ arylalkyl; R₃ and R₄ are independently hydrogen or a C₁-C₆ alkyl group; and X— is a halide (such as chloride, bromide, or iodide), carbonate, sulfonate, phosphate, or the anion of an organic carboxylic acid (such as acetate). In aspects, the imidazoline compound includes 1-benzyl-1-(2-hydroxyethyl)-2-tall-oil-2-imidazolinium chloride.

The one or more of the corrosion inhibitor compounds can comprise a bis-quaternized imidazole derivative having the formula (III):

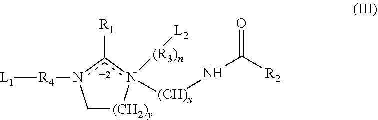

wherein R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; R₃ and R₄ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof; L₁ and L₂ are each independently absent, H, —COOH, —SO₃H, —PO₃H₂, —COOR₅, —CONH₂, —CONHR₅, or —CON(R₅)₂; R₅ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5. In aspects, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are C₁-C₁₀ alkylene, C₂-C₈ alkylene, C₂-C₆ alkylene, or C₂-C₃ alkylene; n is 0 or 1; x is 2; y is 1; R₃ and R₄ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R₃ and R₄ can be C₂-C₃ alkylene such as —C₂H₂—; n is 1 and L₂ is —COOH or n is 0 and L₂ is absent or H; x is 2; y is 1; R₃ and R₄ are —C₂H₂—; and L₁ is —COOH.

It should be appreciated that the number of carbon atoms specified for each group of formula (III) refers to the main chain of carbon atoms and does not include carbon atoms that may be contributed by substituents.

In aspects, the one or more of the corrosion inhibitor compounds can comprise an imidazoline derived from a tall oil fatty acid and diethylene triamine (TOFA/DETA).

### Quaternary Ammonium Compounds

In aspects, the one or more of the corrosion inhibitor compounds can comprise a quaternary ammonium compound. Suitable quaternary ammonium compounds can include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, trialkyl benzyl quaternary ammonium compounds, or combinations thereof. In compounds having one or more alkyl groups, the alkyl group can contain from about 6 to about 24 carbon atoms; alternatively, from about 10 to about 18 carbon atoms; alternatively, from about 12 to about 16 carbon atoms. Examples of quaternary ammonium compounds that are referred to as “quats” can include, but are not limited to, trialkyl-, dialkyl-, dialkoxy alkyl-, monoalkoxy-, benzyl-, and imidazolinium-quaternary ammonium compounds and salts thereof.

Examples of the quaternary ammonium compound that are salts include an alkylamine benzyl quaternary ammonium salt, a benzyl triethanolamine quaternary ammonium salt, a benzyl dimethylaminoethanolamine quaternary ammonium salt, or combinations thereof.

Additional examples of alkyl-, hydroxyalkyl-, alkylaryl-, arylalkyl-, and aryl-amine quaternary salts include those having the formula [N⁺R^{5a}R^{6a}R^{7a}R^{8a}][X⁻], wherein R^{5a}, R^{6a}, R^{7a}, and R^{8a} contain one to 18 carbon atoms, and X is Cl, Br or I. In certain embodiments, R^{5a}, R^{6a}, R^{7a}, and R^{8a} are each independently selected from the group consisting of alkyl (e.g., C₁-C₁₈ alkyl), hydroxyalkyl (e.g., C₁-C₁₈ hydroxyalkyl), and arylalkyl (e.g., benzylakyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I.

The one or more of the corrosion inhibitor compounds can comprise a quaternary ammonium compound of Formula (IV):

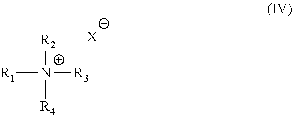

wherein R₁, R₂, and R₃ are independently C₁ to C₂₀ alkyl, R₄ is methyl or benzyl, and X is a halide or methosulfate.

In aspects, the quaternary ammonium compound can be represented by the formula (V):

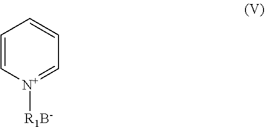

wherein R₁ is an alkyl group, an aryl group, or an arylalkyl group, wherein the alkyl groups have from 1 to about 18 carbon atoms and B is C₁, Br or I. Among these compounds are alkyl pyridinium salts and alkyl pyridinium benzyl quats. Examples include methylpyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium, an alkyl benzyl pyridinium chloride, or combinations thereof. In aspects, the alkyl group is a C₁-C₆ hydrocarbyl group. In some aspects, the quaternary ammonium compound includes benzyl pyridinium chloride.

### Organic Sulfur Compounds

The one or more of the corrosion inhibitor compounds can comprise an organic sulfur compound, including but not limited to a thiol (also known as a mercaptan), an organic disulfide, or combinations thereof. Examples of thiols include 2-mercaptoehtanol, mercaptoacetic acid, or combinations thereof. Examples of disulfide compounds have the following formula (VI):

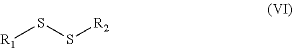

where R₁ and R₂ are each independently selected from a C₁-C₁₀-alkyl group, a C₂-C₁₀-alkenyl group, a C₂-C₁₀-alkynyl group, a C₆-C₁₂-aryl group, a monocyclic or bicyclic heteroaryl group, monocyclic or bicyclic heterocycle group, and C₃-C₈-cycloalkyl group, wherein each alkyl, alkenyl, alkynyl, aryl, heteroaryl, heterocycle, and cycloalkyl group is independently unsubstituted or substituted with 1 to 3 substituents independently selected from —F, —Cl, —NO₂, —CN, —OH, —NH₂, a C₁-C₆ alkyl group, a C₁-C₆ haloalkyl group, a C₁-C₆ alkoxy group, —CO₂R³, and —CON(R⁴)₂, wherein R³ and R⁴, at each occurrence, are each independently selected from hydrogen and a C₁-C₆ alkyl group. Other exemplary disulfide compounds are disclosed in U.S. Pat. No. 9,238,588 B2, which is incorporated by reference in its entirety.

### Phosphate Esters

In aspects, the one or more of the corrosion inhibitor compounds can comprise: mono-, di- or tri-alkyl or alkylaryl phosphate esters; phosphate esters of hydroxylamines; phosphate esters of polyols, or combinations thereof. The one or more corrosion inhibitor compounds can comprise a phosphate ester. Suitable mono-, di- and tri-alkyl as well as alkylaryl phosphate esters and phosphate esters of mono, di, and triethanolamine typically contain between from 1 to about 18 carbon atoms. Mono-, di- and trialkyl phosphate esters, alkylaryl or arylalkyl phosphate esters can be those prepared by reacting a C₃-C₁₈ aliphatic alcohol with phosphorous pentoxide. The phosphate intermediate interchanges its ester groups with triethylphosphate, producing a broader distribution of alkyl phosphate esters.

Alternatively, the phosphate ester can be made by admixing with an alkyl diester, a mixture of low molecular weight alkyl alcohols or diols. The low molecular weight alkyl alcohols or diols can include C₆ to C₁₀ alcohols or diols. In aspects, the phosphate esters can be phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine.

### Monomeric or Oligomeric Fatty Acids

The one or more of the corrosion inhibitor compounds can comprise a monomeric or oligomeric fatty acid. In aspects, the monomeric or oligomeric fatty acids can be C₁₄-C₂₂ saturated and unsaturated fatty acids as well as dimer, trimer, and oligomer products obtained by polymerizing one or more of such fatty acids.

### Alkoxylated Amines

The one or more of the corrosion inhibitor compounds can comprise a an alkoxylated amine. The alkoxylated amine can be an ethoxylated alkyl amine. The alkoxylated amine can be ethoxylated tallow amine.

### Solvents

The one or more solvents may comprise water, alcohols, hydrocarbons, ketones, ethers, aromatics, amides, nitriles, sulfoxides, esters, glycol ethers, aqueous systems, and combinations thereof. In certain embodiments, the solvent is water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or combinations thereof. Representative polar solvents suitable for formulation with the composition include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, 1,2-propylene glycol, 1,3-propylene glycol, ethylene glycol monobutyl ether, etc.), ketones (cyclohexanone, diisobutylketone), N-methylpyrrolidinone (NMP), N,N-dimethylformamide, or combinations thereof. Representative non-polar solvents suitable for formulation with the composition include aliphatic hydrocarbons such as pentane, hexane, cyclohexane, methylcyclohexane, heptane, decane, dodecane, diesel, or combinations thereof; aromatic hydrocarbons such as toluene, xylene, heavy aromatic naphtha, fatty acid derivatives (acids, esters, amides), or combinations thereof; or any combination of aliphatic hydrocarbons and aromatic hydrocarbons.

In some aspects, the solvent is xylene.

In certain embodiments, the solvent is a polyhydroxylated solvent, a polyether, an alcohol, or a combination thereof. In certain embodiments, the solvent is monoethyleneglycol, methanol, dimethyl sulfoxide (DMSO), dimethylformamide (DMF), tetrahydrofuran (THF), or a combination thereof.

### Concentrations

In aspects, the corrosion inhibitor composition can include the carbon-based nanoparticles in an amount of from about 0.1 wt % to about 99 wt %; alternatively, from about 0.1 wt % to about 50 wt %; alternatively, from about 0.1 wt % to about 40 wt %; alternatively, from about 0.1 wt % to about 30 wt %; alternatively, from about 0.1 wt % to about 20 wt %; alternatively, from about 0.1 wt % to about 10 wt %; alternatively, from about 0.1 wt % to about 9 wt %; alternatively, from about 0.1 wt % to about 8 wt %; alternatively, from about 0.1 wt % to about 7 wt %; alternatively, from about 0.1 wt % to about 6 wt %; alternatively, from about 0.1 wt % to about 5 wt %; alternatively, from about 0.1 wt % to about 4 wt %; from about 0.1 wt % to about 3 wt %; alternatively, from about 0.1 wt % to 2 wt %; alternatively, from about 0.1 wt % to about 1 wt %; alternatively, from about 0.1 wt % to about 0.5 wt %; alternatively, from about 0.5 wt % to about 1 wt %; alternatively, from about 1 wt % to about 2 wt %; alternatively, from about 1 wt % to about 3 wt %; alternatively, from about 2 wt % to about 3 wt %, based on a total sum weight of based on a total weight of the corrosion inhibitor composition. In aspects, the concentration of carbon-based nanoparticles in the corrosion inhibitor composition can be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 wt % based on a total weight of the corrosion inhibitor composition.

In aspects, the corrosion inhibitor composition can include one or more corrosion inhibitor compounds in an amount of from about 1 wt % to about 99 wt %; alternatively, from about 5 wt % to about 90 wt %; alternatively, from about 50 wt % to about 90 wt %; based on a total weight of the corrosion inhibitor composition.

In aspects, a weight ratio of the i) corrosion inhibitor compound(s) to the ii) carbon-based nanoparticles, is in a range of from 10:1 to 500:1; alternatively, from 10:1 to 200:1; alternatively, from 10:1 to 100:1; alternatively, from 15:1 to 100:1; alternatively, from 20:1 to 100:1.

In aspects, the corrosion inhibitor composition can include one or more solvents in an amount of from 1 wt % to 99 wt %; alternatively, from 1 wt % to 98 wt %; alternatively, from 20 wt % to 95 wt %; alternatively, from 25 wt % to 90 wt %; alternatively, from 30 wt % to 85 wt %; alternatively, from 35 wt % to 80 wt %; alternatively, from 35 wt % to 75 wt %; alternatively, from 40 wt % to 70 wt %; alternatively, from 45 wt % to 65 wt %; alternatively, from 50 wt % to 60 wt %, of one or more solvents, based on total weight of the corrosion inhibitor composition. In certain embodiments, a corrosion inhibitor composition disclosed herein can include 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or 95 wt % of one or more solvents, based on total weight of the corrosion inhibitor composition. In certain embodiments, a corrosion inhibitor composition comprises 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, or 99 wt % of one or more solvents, based on total weight of the corrosion inhibitor composition.

### Additional Components

Additional components for inclusion in the compositions include asphaltene inhibitors, paraffin inhibitors, scale inhibitors, emulsifiers, water clarifiers, dispersants, emulsion breakers, hydrogen sulfide scavengers, gas hydrate inhibitors, biocides, pH modifiers, surfactants, functional agents and other additives, or combinations thereof.

### Asphaltene Inhibitors

The corrosion inhibitor composition can additionally include an asphaltene inhibitor. Examples of asphaltene inhibitors include, but are not limited to, aliphatic sulphonic acids; alkyl aryl sulphonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids; salts of alkyl succinates; sorbitan monooleate; and polyisobutylene succinic anhydride, or combinations thereof.

### Paraffin Inhibitors

The corrosion inhibitor composition disclosed herein can additionally include one or more paraffin inhibitors. Examples of paraffin inhibitors include, but are not limited to, paraffin crystal modifiers, and dispersant/crystal modifier combinations. Examples of paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax, asphaltenes, or combinations thereof. Examples of dispersants include, but are not limited to, dodecyl benzene sulfonate, oxyalkylated alkylphenols, and oxyalkylated alkylpnenolic resins, or combinations thereof.

### Scale Inhibitors

The corrosion inhibitor composition disclosed herein can additionally include one or more scale inhibitors, e.g., iron-based scale that is contained in a fluid being treated. Examples of scale inhibitors include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), salts of a polymaleic acid/acrylic acid/acrylamido-methyl propane sulfonate terpolymer (PMA/AMPS), or combinations thereof.

### Emulsifiers

The corrosion inhibitor composition disclosed herein can additionally include one or more emulsifier. Examples of emulsifiers include, but are not limited to, salts of carboxylic acids, products of acylation reactions between carboxylic acids or carboxylic anhydrides and amines, alkyl-, acyl-, and amide derivatives of saccharides (alkyl-saccharide emulsifiers), or combinations thereof.

### Water Clarifiers

The corrosion inhibitor composition disclosed herein can include one or more water clarifiers. Examples of water clarifiers include, but are not limited to, inorganic metal salts such as alum, aluminum chloride, and aluminum chlorohydrate; organic polymers such as acrylic acid-based polymers; acrylamide-based polymers; polymerized amines; alkanolamines; thiocarbamates; cationic polymers such as diallyldimethylammonium chloride (DADMAC); or combinations thereof.

### Dispersants

The corrosion inhibitor composition can additionally include one or more dispersants. Examples of dispersants include, but are not limited to, aliphatic phosphonic acids with 2 to 50 carbon atoms (e.g., hydroxyethyl diphosphonic acid), aminoalkyl phosphonic acids (e.g., polyaminomethylene phosphonates with 2 to 10 N atoms, for example, each bearing at least one methylene phosphonic acid group), or combinations thereof. Examples of polyaminomethylene phosphonates are ethylenediamine tetra(methylene phosphonate), diethylenetriamine penta(methylene phosphonate), triamine- and tetramine-polymethylene phosphonates with 2-4 methylene groups between each N atom, at least 2 of the numbers of methylene groups in each phosphonate being different, or combinations thereof. Other dispersants can include lignin or derivatives of lignin such as lignosulfonate and naphthalene sulfonic acid and derivatives.

### Emulsion Breakers

The corrosion inhibitor composition can additionally include one or more emulsion breakers. Examples of emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, resins such as phenolic resins and epoxide resins, or combinations thereof.

### Hydrogen Sulfide Scavengers

The corrosion inhibitor composition can additionally include one or more hydrogen sulfide scavengers. Examples of additional hydrogen sulfide scavengers include, but are not limited to, oxidants (e.g., inorganic peroxides such as sodium peroxide, or chlorine dioxide), aldehydes (e.g., of 1 to 10 carbon atoms such as formaldehyde or glutaraldehyde or (meth)acrolein), triazines (e.g., monoethanol amine triazine, monomethylamine triazine, and triazines from multiple amines or mixtures thereof), glyoxal, or combinations thereof.

### Gas Hydrate Inhibitors

The corrosion inhibitor composition can additionally include one or more gas hydrate inhibitors. Examples of gas hydrate inhibitors include, but are not limited to, thermodynamic hydrate inhibitors (THI), kinetic hydrate inhibitors (KHI), anti-agglomerates (AA), or combinations thereof.

Examples of thermodynamic hydrate inhibitors include, but are not limited to, NaCl salt, KCl salt, CaCl₂) salt, MgCl₂ salt, NaBr₂ salt, formate brines (e.g. potassium formate), polyols (e.g., glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, sugar alcohols (e.g. sorbitol, mannitol), or combinations thereof), methanol, propanol, ethanol, glycol ethers (e.g., diethyleneglycol monomethylether, ethyleneglycol monobutylether, or combinations thereof), alkyl or cyclic esters of alcohols (e.g., ethyl lactate, butyl lactate, methylethyl benzoate, or combinations thereof), or combinations thereof.

Examples of kinetic hydrate inhibitors and anti-agglomerates include, but are not limited to, polymers and copolymers, polysaccharides (e.g., hydroxy-ethylcellulose (HEC), carboxymethylcellulose (CMC), starch, starch derivatives, xanthan, or combinations thereof), lactams (e.g., polyvinylcaprolactam, polyvinyl lactam), pyrrolidones (e.g., polyvinyl pyrrolidone of various molecular weights), surfactants (e.g., fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines, or combinations thereof), hydrocarbon based dispersants (e.g., lignosulfonates, iminodisuccinates, polyaspartates, or combinations thereof), amino acids, proteins, or combinations thereof.

### Biocides

The corrosion inhibitor composition can additionally include one or more biocides.

Examples of biocides include, but are not limited to, oxidizing and non-oxidizing biocides. Examples of non-oxidizing biocides include, for example, aldehydes (e.g., formaldehyde, glutaraldehyde, acrolein, or combinations thereof), amine-type compounds (e.g., quaternary amine compounds, cocodiamine, or a combination thereof), halogenated compounds (e.g., bronopol, 2-2-dibromo-3-nitrilopropionamide (DBNPA), or a combination thereof), sulfur compounds (e.g., isothiazolone, carbamates, metronidazole, or a combination thereof), quaternary phosphonium salts (e.g., tetrakis(hydroxymethyl)phosphonium sulfate (THPS)), or combinations thereof.

Examples of oxidizing biocides include sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxides, or combinations thereof.

### pH Modifiers

The corrosion inhibitor composition can additionally include one or more pH modifiers. Examples of pH modifiers include, but are not limited to, alkali hydroxides, alkali carbonates, alkali bicarbonates, alkaline earth metal hydroxides, alkaline earth metal carbonates, alkaline earth metal bicarbonates, or combinations thereof. Exemplary pH modifiers include NaOH, KOH, Ca(OH)₂, CaO, Na₂CO₃, KHCO₃, K₂CO₃, NaHCO₃, MgO, and Mg(OH)₂, or combinations thereof.

### Surfactants

The corrosion inhibitor composition can additionally include one or more surfactants. Examples of surfactants include, but are not limited to, anionic surfactants, cationic surfactants, zwitterionic surfactants, and nonionic surfactants.

Anionic surfactants include alkyl aryl sulfonates, olefin sulfonates, paraffin sulfonates, alcohol sulfates, alcohol ether sulfates, alkyl carboxylates, alkyl ether carboxylates, alkyl phosphate esters, ethoxylated alkyl phosphate esters, and mono- and di-alkyl sulfosuccinates, mono- and di-alkyl sulfosuccinamates, or combinations thereof.

Cationic surfactants include alkyl trimethyl quaternary ammonium salts, alkyl dimethyl benzyl quaternary ammonium salts, dialkyl dimethyl quaternary ammonium salts, imidazolinium salts, or combinations thereof.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, alkyl polyethylene glycol esters and diesters, or combinations thereof. Examples of nonionic surfactants also include betaines, sultanes, amphoteric surfactants (e.g., alkyl amphoacetates and amphodiacetates, alkyl amphopropripionates and amphodipropionates, alkyliminodiproprionate, or combinations thereof), or combinations thereof.

In some aspect, a surfactant may be a quaternary ammonium compound, an amine oxide, an ionic or non-ionic surfactant, or any combination thereof. Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhyexyl) dimethyl quaternary ammonium methyl sulfate.

### Functional Agents and Other Additives

The corrosion inhibitor composition may further include additional functional agents or additives that provide a beneficial property. For example, additional agents or additives may be selected from the group consisting of pH adjusters or other neutralizing agents, surfactants, emulsifiers, sequestrants, solubilizers, other lubricants, buffers, detergents, cleaning agent, rinse aid composition, secondary anti-corrosion agent, preservatives, binders, thickeners or other viscosity modifiers, processing aids, carriers, water-conditioning agents, foam inhibitors or foam generators, threshold agent or system, aesthetic enhancing agent (i.e., dye, odorant, perfume), other agents or additives suitable for formulation with a corrosion inhibitor composition and the like, and mixtures thereof. Additional agents or additives will vary according to the particular corrosion inhibitor composition being manufactured.

The corrosion inhibitor composition made may further include additional functional agents or additives that provide a beneficial property. Additional agents or additives will vary according to the particular composition being manufactured and its intended use as one skilled in the art will appreciate. According to one embodiment, the compositions do not contain any of the additional agents or additives.

### Concentration of Additional Components

A corrosion inhibitor composition described herein may comprise from 0 wt % to 80 wt %, 0 wt % to 60 wt %, or 0 wt % to 50 wt % of one or more additional components, based on total weight of the composition. In some aspects, a corrosion inhibitor composition disclosed herein can have at least 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt %, 10.5 wt %, 11.0 wt %, 11.5 wt %, 12.0 wt %, 12.5 wt %, 13.0 wt %, 13.5 wt %, 14.0 wt %, 14.5 wt %, or 15.0 wt % of one or more additional components, based on total weight of the composition; and less than 80, 79, 78, 77, 76, 75, 74, 73, 72, 71, 70, 69, 68, 67, 66, 65, 64, 63, 62, 61, or 60 wt % of the one or more additional components based on total weight of the composition.

### Corrosion Inhibitor Composition in a Container

In aspects, the corrosion inhibitor composition can be contained in a container. A container can be referred to as a pod, box, capsule. In some aspects, the container is a water-soluble container comprising a cellulose-based material or a gelatin. In some aspects, the water-soluble container is biodegradable.

The container can be constructed from one or more water-dispersible and/or biodegradable compositions. Such water-soluble and biodegradable compositions and/or films can include a first layer having a water-soluble material and a second layer having a biodegradable material. Any suitable number of layers may be chosen and each layer may be independently selected from, for example, a water-soluble layer, an oil-soluble layer, a biodegradable layer, etc. Based on the different numbers of layers and different types of layers, the timing of chemical release may be controlled.

The term “water-soluble,” as used herein, refers to the capability of being at least partially soluble and subsequently partially dispersible (e.g., at least about 70% dispersible) to nearly completely dispersible (e.g., about 100% dispersible) in an aqueous solution, such as water. Contacting the water-soluble container can result in fragmentation of the composition into particulates and/or micro-particulates, where a water-dispersible layer or sheet can form such particulates in an aqueous solution. Water-soluble materials, as referenced herein, include materials and papers referred to in the art as “water-soluble,” where only a portion of the paper may be actually soluble in water, but dissolution of this soluble portion results in dispersion of most or all of the remaining structure.

The term “biodegradable,” as used herein, refers to materials that can be readily decomposed by biological methods, through a combination of heat, moisture, and/or microbial action.

Other suitable materials for the water-soluble container include paper, board stock, cardboard, corrugate, or any combination thereof.

In some aspects, the water-soluble container comprises a water dissolvable polymer or polymer coating. The water dissolvable polymer or polymer coating can include a polyvinyl alcohol (PVA) polymer.

For liquid compositions disposed within a container, such compositions can further include a water-soluble salt weighting agent. Examples of weighting agent include, but are not limited to, sodium chloride, sodium bromide, sodium iodide, calcium chloride, calcium bromide, or calcium iodide. In some aspects, the weighting agent comprises sodium chloride. In some aspects, the weighting agent comprises sodium bromide.

The overall amount of the chemical in the container may be chosen based on the size of the container, the dose size of the corrosion inhibitor that should be added to a fluid, the size of inlets into which the container can be introduced into equipment, or combinations thereof. In some embodiments, the amount of corrosion inhibitor composition in the container may range from about 1 ml to about 5 L, for example. In some embodiments, the amount is from about 1 ml to about 10 ml; alternatively, from about 1 ml to about 50 ml; alternatively, from about 1 ml to about 100 ml; alternatively, from about 1 ml to about 500 ml, about 1 ml to about 1 L, about 1 ml to about 3 L, about 100 ml to about 5 L; alternatively, from about 500 ml to about 5 L; alternatively, from about 1 L to about 5 L; alternatively, from about 3 L to about 5 L.

Additionally, the container may have a diameter-to-depth (or diameter-to-length) ratio ranging from about 1:10 to about 10:1; alternatively, about 1:7, about 1:5, about 1:3, about 1:1, about 3:1, about 5:1, or about 7:1. Various thicknesses of the container wall are contemplated and, in some embodiments, thickness may be chosen as a factor to determine how quickly a water-soluble container will dissolve. For example, a water-soluble container having a wall thickness from about 1 mm to about 25 mm may dissolve faster than a water-soluble container having a wall thickness greater than about 25 mm.

### Corrosion Inhibitor Composition in a Tablet

In some aspects, the corrosion inhibitor composition is in the form of a tablet. The tablet can alternatively be referred to as a puck, a pellet, a stick, a rod, a snake, a block, or a marble.

The tablet can be prepared by combining a powder with the liquid treatment chemical in appropriate ratios to form a mixture. The mixture may then be molded or formed into a tablet. In aspects, the powder can be a solid material that binds together, such as sodium bicarbonate, citric acid, or a combination thereof. The powder functions as a carrier or excipient for the corrosion inhibitor composition.

In aspects, the amount of powder in the tablet can be from about 40 wt % to about 99 wt; alternatively, from about 50 wt % to about 95 wt %; alternatively, from about 70 wt % to about 95 wt %; alternatively, from about 70 wt % to about 90 wt %; alternatively, from about 75 wt % to about 90 wt %; alternatively, from about 75 wt % to about 85 wt % based on a total weight of the tablet. In some aspects, the amount of powder in the tablet can be about 80 wt %, about 82 wt %, about 84 wt %, about 86 wt %, about 76 wt %, or about 78 wt % based on a total weight of the tablet.

In aspect, the amount of liquid corrosion inhibitor composition used to form the tablet can be from about 1 wt % to about 60 wt; alternatively, from about 1 wt % to about 40 wt %; alternatively, from about 5 wt % to about 35 wt %; alternatively, from about 5 wt % to about 30 wt %; alternatively, from about 5 wt % to about 25 wt %; alternatively, from about 10 wt % to about 25 wt %. In some aspects, the amount of liquid treatment chemical used to form the tablet can be about 20 wt %, about 18 wt %, about 16 wt %, about 14 wt %, about 24 wt %, or about 22 wt % based on a total weight of the tablet.

The overall size of the tablet can be based on the dose size of the corrosion inhibitor that should be added to a fluid, the size of inlets into which the tablet can be introduced into equipment, or a combination thereof. In some embodiments, the size of the tablet may range from about 1 gram to about 1 kg or more if desired. In some embodiments, the size is from about 1 gram to about 10 grams, about 1 gram to about 50 grams, about 1 gram to about 100 grams, about 1 gram to about 300 grams, about 1 gram to about 500 grams, about 1 gram to about 750 grams, about 10 grams to about 1 kg, about 50 grams to about 1 kg, about 100 grams to about 1 kg, about 300 grams to about 1 kg, about 500 grams to about 1 kg, or about 750 grams to about 1 kg.

Additionally, the tablet may have a diameter-to-depth (or diameter-to-length) ratio ranging from about 1:10 to about 10:1; alternatively, about 1:7, about 1:5, about 1:3, about 1:1, about 3:1, about 5:1, or about 7:1.

In some embodiments, the tablet (in any shape) may have a length, width, and/or depth ranging from about 12.7 mm to about 304.8 mm (about 0.5 inches to about 12 inches); alternatively, from about 12.7 mm to about 25.4 mm (about 0.5 inches to about 1 inch); alternatively, from about 12.7 mm to 50.8 mm (about 0.5 inches to about 2 inches); alternatively, from about 12.7 mm to about 76.2 mm (about 0.5 inches to about 3 inches); alternatively, from about 12.7 mm to about 101.6 mm (about 0.5 inches to about 4 inches); alternatively, from about 12.7 mm to about 127 mm (about 0.5 inches to about 5 inches); alternatively, from about 12.7 mm to about 154.2 mm (about 0.5 inches to about 6 inches); alternatively, from about 12.7 mm to about 177.8 mm (about 0.5 inches to about 7 inches); alternatively, from about 12.7 mm to about 203.2 mm (about 0.5 inches to about 8 inches); alternatively, from about 12.7 mm to about 228.6 mm (about 0.5 inches to about 9 inches).

In aspects where the tablet is in the shape of a marble, sphere, or other circular shape, the shape may have any desirable diameter, such as from about 12.7 mm to about 304.8 mm (about 0.5 inches to about 12 inches); alternatively, from about 25.4 mm to about 304.8 mm (from about 1 inch to about 12 inches; alternatively, from about 50.8 mm to about 304.8 mm (about 2 inches to about 12 inches); alternatively, from about 76.2 mm to about 304.8 mm (about 3 inches to about 12 inches); alternatively, from about 101.6 mm to about 304.8 mm (about 4 inches to about 12 inches); alternatively, from about 127 mm to about 304.8 mm (about 5 inches to about 12 inches); alternatively, from about 152.4 mm to about 304.8 mm (about 6 inches to about 12 inches); alternatively, from about 177.8 mm to about 304.8 mm (about 7 inches to about 12 inches); alternatively, from about 203.2 mm to about 304.8 mm (about 8 inches to about 12 inches); alternatively, from about 228.6 mm to about 304.8 mm (about 9 inches to about 12 inches); alternatively, from about 254 mm to about 304.8 mm (about 10 inches to about 12 inches); alternatively, from about 279.4 mm to about 304.8 mm (about 11 inches to about 12 inches).

In some aspects, the tablet includes a coating on an outer surface of the solidified mixture of powder and corrosion inhibitor composition. For example, the tablet coating can be a water-soluble material, such as gelatin.

### Use and Methods

The corrosion inhibitor compositions can be used in any industry where it is desirable to inhibit corrosion on a metal surface. For example, the corrosion inhibitor compositions may be used for inhibiting corrosion on metal surfaces used in oil and gas applications, in water systems, in condensate/oil systems/gas systems, or any combination thereof.

A method can include preparing a corrosion inhibitor composition by mixing carbon-based nanoparticles, one or more corrosion inhibitor compounds, and a solvent. In aspects, the carbon-based nanoparticles have not been subjected to a chemical reaction resulting in the formation of covalent bonds between the carbon-based nanoparticles and a compound or compounds.

Other methods can be performed after the corrosion inhibitor composition is prepared.

Another method can include preparing a container comprising a corrosion inhibitor composition by: mixing carbon-based nanoparticles, one or more corrosion inhibitor compounds, and a solvent to form the corrosion inhibitor composition, and introducing the corrosion inhibitor composition into the container. In aspects, the carbon-based nanoparticles have not been subjected to a chemical reaction resulting in the formation of covalent bonds between the carbon-based nanoparticles and a compound or compounds.

Another method can include preparing a tablet comprising a corrosion inhibitor composition by: mixing carbon-based nanoparticles, one or more corrosion inhibitor compounds, and a solvent to form the corrosion inhibitor composition; mixing the corrosion inhibitor composition with a powder; and forming the powder into the tablet. In aspects, the carbon-based nanoparticles have not been subjected to a chemical reaction resulting in the formation of covalent bonds between the carbon-based nanoparticles and a compound or compounds.

Another method can include contacting a fluid comprising the corrosion inhibitor composition disclosed herein with a metal surface. Prior to contacting, a tablet or container containing the corrosion inhibitor composition can be added to the fluid, and at least a portion of the tablet or container can dissolve in the fluid so that the corrosion inhibitor composition contacts the fluid.

Another method can include introducing, adding, or injecting the corrosion inhibitor composition into a fluid to inhibit corrosion on a metal surface that is in contact with the fluid.

Another method can include introducing, adding, or injecting a container or tablet comprising the corrosion inhibitor composition into a fluid to inhibit corrosion on a metal surface that is in contact with the fluid. After introducing, adding, or injecting, the tablet or container containing the corrosion inhibitor composition can dissolve in the fluid so that the corrosion inhibitor composition contacts the fluid.

Another method can include introducing, adding, or injecting the corrosion inhibitor composition into an fluid i) produced or used in the production, transportation, storage, and/or separation of crude oil or natural gas or ii) in a waste-water process, a cooling water system for a nuclear power plant, geothermal pipelines, a desalination plant, a farm, a slaughter house, an anaerobic digestion process for producing biogas; a land-fill, a municipal waste-water plant, a coking coal process, a coal-fired power plant, or a biofuel process. In such methods, the method can additionally include producing, transporting, storing, or separating the fluid, prior to introducing, adding, or injecting the corrosion inhibitor composition into the fluid. Producing the fluid can include producing a production fluid from a wellbore formed in a subterranean formation.

Another method can include introducing, adding, or injecting a container or tablet comprising the corrosion inhibitor composition into an fluid i) produced or used in the production, transportation, storage, and/or separation of crude oil or natural gas or ii) in a waste-water process, a cooling water system for a nuclear power plant, geothermal pipelines, a desalination plant, a farm, a slaughter house, an anaerobic digestion process for producing biogas; a land-fill, a municipal waste-water plant, a coking coal process, a coal-fired power plant, or a biofuel process. In such methods, the method can additionally include producing, transporting, storing, or separating the fluid, prior to introducing, adding, or injecting the corrosion inhibitor composition into the fluid. Producing the fluid can include producing a production fluid from a wellbore formed in a subterranean formation. After introducing, adding, or injecting, the tablet or container containing the corrosion inhibitor composition can dissolve in the fluid so that the corrosion inhibitor composition contacts the fluid.

Another method can include transporting or moving the fluid (into which the corrosion inhibitor composition was added, introduced, or injected) in an oil or gas pipeline. This method can be a step of another method that introduces, adds, or injects the corrosion inhibitor composition to the fluid, optionally in a container or as part of a tablet that dissolves in the fluid.

Any of the above methods or another method can include coating the metal surface of an equipment (e.g., a pipe, a pipeline, a heat exchanger, a buffer storage vessel, or a treatment vessel) with the corrosion inhibitor composition, wherein the corrosion inhibitor composition is added, introduced, or injected into a fluid contained in or moving through the equipment in a high dose (e.g., pill) in a concentration disclosed herein.

The fluid can further comprise one or more hydrocarbons and/or one or more gases.

In some aspects, the fluid is in a liquid phase. In aspects, the fluid flows through equipment (e.g., a pipe, a pipeline, a heat exchanger, a buffer storage vessel, or a treatment vessel). In some aspects, the corrosion inhibitor composition may be introduced, added, or injected into the fluid continuously. In some aspects, the corrosion inhibitor composition may be introduced, added, or injected into the fluid continuously in amounts designed to achieve a weight basis concentration of from 5 ppmw to 5,000 ppmw based upon a total weight of the fluid. Alternatively, the corrosion inhibitor composition may be introduced, added, or injected into the fluid discontinuously but in regular doses (e.g., pills, periodic batch) in amounts that are designed to coat an inner wall of an equipment. Such discontinuous introduction, addition, or injection may be made to achieve from 50,000 ppmw to 900,000 ppmw based on a total weight of the fluid. While such discontinuous introduction, addition, or injection may be carried out as often or as seldom as desired, in aspects, it is carried out at a frequency of from about once per week to about once every three months.

In some aspects, the fluid is static in a vessel and the corrosion inhibitor composition is introduced, added, or injected into the vessel in amounts designed to achieve a concentration of the composition of from 5 ppmw to 5,000 ppmw, based on a total weight of the fluid.

Regardless of whether the fluid is static or flowing, in aspects, the corrosion inhibitor composition is typically introduced, added, or injected to the fluid in an amount to provide an effective concentration of the described corrosion inhibitor composition, such as from about 0.01 ppmw to about 5,000 ppmw based on a total weight of the fluid. In certain embodiments, the corrosion inhibitor composition may be added, introduced, or injected into the fluid to provide to provide an effective concentration of the described corrosion inhibitor composition of from about 1 ppmw to about 1,000,000 ppmw; alternatively, from about 1 ppmw to about 100,000 ppmw; alternatively, from about 10 ppmw to about 75,000 ppmw; alternatively, from about 100 ppmw to about 10,000 ppmw; alternatively, from about 200 ppmw to about 8,000 ppmw; alternatively, from about 500 ppmw to about 6,000 ppmw based on a total weight of the fluid.

In some aspects, the fluid can comprise liquid hydrocarbons. The liquid hydrocarbons can include, but are not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof.

While a temperature of the fluid is ordinarily from about 40° C. to about 250° C., it may be from about −50° C. to 300° C., 0° C. to 200° C., 10° C. to 100° C., or 20° C. to 90° C. In some aspects, the fluid may be at a temperature of 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., or 40° C. In some aspects, the fluid may be at a temperature of 85° C., 86° C., 87° C., 88° C., 89° C., 90° C., 91° C., 92° C., 93° C., 94° C., 95° C., 96° C., 97° C., 98° C., 99° C., or 100° C.

The corrosion inhibitor compositions disclosed herein may be introduced, added, or injected into a fluid comprising an aqueous fluid having a water concentration of from 1% to 100% volume/volume (v/v), from 1% to 80% v/v, or from 1% to 60% v/v of the fluid. In aspects, the aqueous fluid can contain various levels of salinity. In aspects, the aqueous fluid can be an acidic or basic aqueous medium. In aspects, the aqueous fluid can further comprise dissolved acidic or basic gases such as, for example, hydrogen sulfide and/or carbon dioxide. In aspects, the aqueous fluid can be a produced water. As used herein, the term “produced water” means water that flows back from a subterranean reservoir and is collected during a hydrocarbon recovery process including, but not limited to hydraulic fracturing and tertiary oil recovery. In some aspects, produced water can include an amount of residual hydrocarbon products (residual after hydrocarbon recovery from the water) and one or more of injectate, connate (native water present in the subterranean formation along with the hydrocarbon), brackish water, and sea water. Produced water can range in temperature from about −30° C. to about 200° C., depending on the temperature in the subterranean formation, the wellbore, the surface, and the temperatures of equipment in between the wellbore and surface.

In aspects, the fluid may be contained in or flow through many different types of equipment, also referred to as apparatuses. In aspects, the apparatuses are downstream of a wellbore, relative to a direction of hydrocarbon flow from a subterranean formation. For example, the fluid may be contained in an apparatus that transports fluid from one location to another location, such as an oil pipeline, a gas pipeline, or an oil or gas pipeline. In certain aspects, the apparatus may be part of an oil and/or gas refinery, such as a pipeline or conduit, a separation vessel, a dehydration unit, or a gas line. The fluid may be contained in or flow through an apparatus used in oil extraction and/or production, such as a wellhead. In other aspects, the apparatus may be part of a coal-fired power plant. In yet other aspects, the apparatus may be a scrubber (e.g., a wet flue gas desulfurizer, a spray dry absorber, a dry sorbent injector, a spray tower, or a contact or bubble tower). In further aspects, the apparatus may be a cargo vessel, a storage vessel, a holding tank, or a pipeline connecting the tanks, vessels, or processing units. In some aspects, the fluid may be contained in water systems, condensate/oil systems/gas systems, or any combination thereof.

The corrosion inhibitor composition may be introduced, added, or injected into the fluid by any appropriate method for combining the corrosion inhibitor composition into the fluid. For example, the corrosion inhibitor composition can be added at a location in process flow that is upstream from the location at which corrosion prevention is desired. The corrosion inhibitor compositions may be injected using mechanical equipment such as a chemical injection pump, a piping tee, an injection fitting, an atomizer (such as in the case of a fluid that is in the gaseous state), an injection valve, or a quill. In some aspects, the corrosion inhibitor compositions may be pumped into an oil and/or gas pipeline using an umbilical line. In other aspects, capillary injection systems can be used to deliver the corrosion inhibitor compositions to a selected fluid.

In some aspects, the method can include, after introducing, adding, or injecting the corrosion inhibitor compositions into the fluid, mixing the fluid and corrosion inhibitor composition to disperse the corrosion inhibitor composition in the fluid.

In aspects, the corrosion inhibitor composition can be introduced, added, or injected into a fluid as an aqueous or nonaqueous solution, mixture, or slurry.

In some aspects, the corrosion inhibitor composition can be added, introduced, or injected as a pill to a fluid moving in an equipment (e.g., a pipeline), providing a high dose (e.g., from 50,000 ppmw to 900,000 ppmw) of the corrosion inhibitor composition to the fluid at the point of addition, introduction, or injection.

The flow rate of a process flow line in which the corrosion inhibitor composition is used may be in a range of from 0 to 100 meters per second, in a range of from 0.1 to 100 meters per second, or in a range of from 0.1 to 50 meters per second.

The corrosion inhibitor compositions disclosed herein may provide at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% corrosion protection for a metal surface, optionally as defined by a 1018 carbon steel coupon in a corrosion bubble cell test. A corrosion bubble cell test may be performed as described for the examples below. The corrosion bubble cell test is a test that compares the performance of one corrosion inhibitor to another, under a testing temperature of about 80° C., a CO₂ saturated fluid of 20 wt % LVT-200 oil and 80 wt % NaCl brine (aqueous 3 wt %), about 3 to 4 hours under conditions prior to composition injection, a test duration of about 15 hours, and a corrosion inhibitor composition dosage of 2 ppm based on water phase.

### EXAMPLES

The following examples are intended to illustrate different aspects and embodiments of the disclosed corrosion inhibitor and are not to be considered limiting. It will be recognized that various modifications and changes may be made to the experimental embodiments described herein, and without departing from the scope of the claims.

Three corrosion inhibitor compositions were tested for corrosion inhibition. Nine coupons, made of sandblast-finished C1018 mild steel, were weighed: two coupons for use as untreated Blanks A and B, three coupons for treatment with the corrosion inhibitor composition of the Comparative Examples A to C, two coupons for treatment with the corrosion inhibitor composition of Examples 1A and 1B, and two coupons for treatment with the corrosion inhibitor composition of Examples 2A and 2B.

### Blanks A and B

Each of the two coupons for use as blanks, corresponding to Blanks A and B, was placed in its own vessel containing a simulated aqueous fluid made of 3% NaCl brine saturated with CO₂. Each such vessel containing a coupon was then mounted on a wheel in a cabinet controlled to a temperature of 60° C. The wheel was rotated at 26 rpm. After each interval of 24 hr, 48 hr, and 72 hr of rotation, the brine in the vessel was replaced with fresh brine. After the last replacement of brine, the wheel continued to be rotated another 24 hr.

After a total of 96 hrs of rotation as described above, the coupons were removed from the vessel, cleaned and reweighed.

### Comparative Examples A, B, and C

A corrosion inhibitor composition (Comparative Example), representing a conventional corrosion inhibitor composition, was prepared by mixing an amount of an imidazoline derived from tall oil fatty acid (TOFA) and diethylenetriamine (DETA) with an amount of xylene so as to achieve an imidazoline concentration of 50 wt %. Three of the above-described coupons were dipped in the composition of the Comparative Example for about 5 s and allowed to drip dry for about 10 s to allow the excess amount of the composition to be removed from the coupon.

Each of the coupons, corresponding to Comparative Examples A, B, and C, was placed in its own vessel containing a simulated aqueous fluid made of 3% NaCl brine saturated with CO₂. Each such vessel containing a coupon was then mounted on a wheel in a cabinet controlled to a temperature of 60° C. The wheel was rotated at 26 rotations per minute (rpm). After each interval of 24 hr, 48 hr, and 72 hr of rotation, the brine in the vessel was replaced with fresh brine. After the last replacement of brine, the wheel continued to be rotated another 24 hr.

After being subjected to corrosive attack by the brine for the time period described above, the coupons were removed from the vessel, cleaned and reweighed.

### Examples 1A and 1B

Another corrosion inhibitor composition was prepared by mixing an amount of the imidazoline derived from TOFA/DETA, an amount of graphene oxide nanoparticles (obtained from Nanografi), and an amount of xylene so as to achieve an imidazoline concentration of 50 wt % and a graphene oxide concentration of 0.5 wt %. Two of the above-described coupons were dipped in the composition for about 5 s and allowed to drip dry for about 10 s to allow the excess amount of the composition to be removed from the coupon.

Each of the two coupons, corresponding to Examples 1A and 1B, was placed in its own vessel containing a simulated aqueous fluid made of 3% NaCl brine saturated with CO₂. Each such vessel containing a coupon was then mounted on a wheel in a cabinet controlled to a temperature of 60° C. The wheel was rotated at 26 rotations per minute (rpm). After each interval of 24 hr, 48 hr, and 72 hr of rotation, the brine in the vessel was replaced with fresh brine. After the last replacement of brine, the wheel continued to be rotated another 24 hr.

After a total of 96 hrs of rotation as described above, the coupons were removed from the vessel, cleaned and reweighed.

### Examples 2A and 2B

Another corrosion inhibitor composition was prepared by mixing an amount of the imidazoline derived from TOFA/DETA and an amount of graphene quantum dots so as to achieve 50 wt % of the imidazoline and 0.5 wt % of the graphene oxide nanoparticles. Two of the above-described coupons were dipped in the composition for about 5 s and allowed to drip dry for about 10 s to allow the excess amount of the composition to be removed from the coupon.

Each of the coupons, corresponding to Examples 2A and 2B, was placed in its own vessel containing a simulated aqueous fluid made of 3% NaCl brine saturated with CO₂. Each such vessel containing a coupon was then mounted on a wheel in a cabinet controlled to a temperature of 60° C. The wheel was rotated at 26 rpm. After each interval of 24 hr, 48 hr, and 72 hr of rotation, the brine in the vessel was replaced with fresh brine. After the last replacement of brine, the wheel continued to be rotated another 24 hr.

After a total of 96 hrs of rotation as described above, the coupons were removed from the vessel, cleaned and reweighed.

### Discussion of Results of the Examples

The amount of coupon mass loss during treatment in the brine was calculated and the corrosion rate in mils per year was calculated for each of the Blanks A and B, Comparative Examples A to C, Examples 1A and 1B, and Examples 2A and 2B. Using the corrosion rate of the blanks as a baseline, the percent protection exhibited by the composition of each of the Comparative Examples A to C, Examples 1A and 1B, and Examples 2A and 2B was calculated. The results are tabulated in Table 1.

TABLE 1
Corrosion rates and percentage protection

| | Corrosion rate | |
|---|---|---|
| Coupon | (mils/yr) | Percentage Protection |
| Blank A | 18.26 | N/A |
| Blank B | 19.99 | N/A |
| Comparative Example A | 13.44 | 30 |
| Comparative Example B | 12.62 | 34 |
| Comparative Example C | 13 | 32 |
| Example 1A | 5.43 | 72 |
| Example 1B | 5.09 | 73 |
| Example 2A | 6.75 | 65 |
| Example 2B | 7.01 | 63 |

As seen in Table 1, the corrosion inhibitor composition of the Comparative Example achieved an average percentage protection against corrosion of 32%. In contrast, the corrosion inhibitor composition of Examples 1A and 1B achieved an average percentage protection against corrosion of 72.5% and the corrosion inhibitor composition of Examples 2A and 2B achieved an average percentage protection against corrosion of 64%. Put another way, in comparison to the Comparative Examples A to C that did not have carbon-based nanoparticles, the corrosion inhibitor composition of Examples 1A and 1B increased corrosion protection by 127% over that of the Comparative Examples A to C, and the corrosion inhibitor composition of Examples 2A and 2B increased corrosion protection by 100% over that of the Comparative Examples A to C.

As shown above, it has been discovered that the inclusion of carbon-based nanoparticles in a corrosion inhibitor composition increases the corrosion inhibition effect in comparison to an otherwise similar corrosion inhibitor composition that does not include the carbon-based nanoparticles. Thus, the corrosion inhibitor compositions and methods disclosed herein provide for a significantly greater performance in inhibition of corrosion. This enhanced effect is achieved for carbon-based nanoparticles that are not bonded to or reacted with the corrosion inhibitor compound that is in the composition.

While the corrosion inhibitor compositions of the Examples were tested in a fluid that did not contain hydrocarbons, the purpose of doing so was to rule out any effect of the presence of hydrocarbons on corrosion protection performance and not to demonstrate that the corrosion inhibitor compositions are only useful without presence of hydrocarbons.

### Additional Description

Aspect 1. A corrosion inhibitor composition comprising: carbon-based nanoparticles; one or more corrosion inhibitor compounds; and one or more solvents.

Aspect 2. The corrosion inhibitor composition of Aspect 1, wherein the carbon-based nanoparticles i) are not covalently bonded to a compound in the corrosion inhibitor composition, ii) do not react with any compound in the corrosion inhibitor composition, or both i) and ii).

Aspect 3. The corrosion inhibitor composition of any one of Aspects 1 or 2, wherein the one or more corrosion inhibitor compounds comprises one or more imidazoline compounds or derivatives thereof, one or more quaternary ammonium compounds, one or more organic sulfur compounds, one or more phosphate esters, one or more monomeric or oligomeric fatty acids, one or more alkoxylated amines, or combinations thereof.

Aspect 4. The corrosion inhibitor composition of any one of Aspects 1 to 3, wherein the corrosion inhibitor composition from about 1 wt % to about 99 wt % of the one or more corrosion inhibitor compounds.

Aspect 5. The corrosion inhibitor composition of any one of Aspects 1 to 4, wherein the carbon-based nanoparticles comprise carbon nanotubes, carbon dots, carbon quantum dots, graphene, graphene quantum dots, graphene oxide, or combination thereof.

Aspect 6. The corrosion inhibitor composition of any one of Aspects 1 to 5, wherein at least one dimension of the carbon-based nanoparticles is in a range of from 1 nm to less than 1,000 nm.

Aspect 7. The corrosion inhibitor composition of any one of Aspects 1 to 6, having from about 0.1 wt % to about 50 wt % of the carbon-based nanoparticles based on a total weight of the corrosion inhibitor composition.

Aspect 8. The corrosion inhibitor composition of any one of Aspects 1 to 7, wherein the corrosion inhibitor composition comprises from about 0.1 wt % to about 1 wt % of the carbon-based nanoparticles.

Aspect 9. The corrosion inhibitor composition of any one of Aspects 1 to 8, wherein a weight ratio of the one or more corrosion inhibitor compounds to the carbon-based nanoparticles is in a range of from 10:1 to 500:1.

Aspect 10. The corrosion inhibitor composition of any one of Aspects 1 to 9, wherein the one or more solvents is selected from water, alcohols, hydrocarbons, ketones, ethers, aromatics, amides, nitriles, sulfoxides, esters, glycol ethers, aqueous systems, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, brine, seawater, glycols, glycol derivatives, ketones, pentane, hexane, cyclohexane, methylcyclohexane, heptane, decane, dodecane, diesel, toluene, xylene, heavy aromatic naphtha, fatty acid derivatives, or combinations thereof.

Aspect 11. The corrosion inhibitor composition of any one of Aspects 1 to 10, wherein the one or more solvents comprises xylene.

Aspect 12. The corrosion inhibitor composition of any one of Aspects 1 to 11, further comprising one or more additional components selected from asphaltene inhibitors, paraffin inhibitors, scale inhibitors, emulsifiers, water clarifiers, dispersants, emulsion breakers, hydrogen sulfide scavengers, gas hydrate inhibitors, biocides, pH modifiers, surfactants, functional agents and other additives, or combinations thereof.

Aspect 13. A method of inhibiting corrosion on a metal surface of an equipment, comprising: i) contacting a fluid comprising the corrosion inhibitor composition of any one of Aspects 1 to 12 with the metal surface; ii) adding, introducing, or injecting the corrosion inhibitor composition of any one of Aspects 1 to 12 into a fluid that is or will be in contact with the metal surface; or iii) both i) and ii).

Aspect 14. The method of Aspect 13, wherein the metal surface is a carbon steel.

Aspect 15. The method of any one of Aspects 13 or 14, wherein the fluid is an aqueous fluid comprising water.

Aspect 16. The method of any one of Aspects 13 to 15, wherein the fluid comprises water and one or more hydrocarbons.

Aspect 17. The method of any one of Aspects 13 to 16, wherein the metal surface is part of equipment used in: a production, transportation, storage, and/or separation of crude oil or natural gas; a coal-fired process; a waste-water process; a farm; a slaughter house; a land-fill; a municipality waste-water plant; a coking coal process; a biofuel process; a cooling water system for a nuclear power plant; a geothermal heating or cooling process; a desalination process; a farm; or a land-fill.

Aspect 18. The method of any one of Aspects 13 to 17, further comprising producing, transporting, storing, or separating the fluid, prior to said contacting, introducing, adding, or injecting of the corrosion inhibitor composition.

Aspect 19. The method of any one of Aspects 13 to 18, further comprising producing the fluid, prior to the contacting, introducing, adding, or injecting of the corrosion inhibitor composition, wherein said producing of the fluid comprises producing a production fluid from a wellbore formed in a subterranean formation.

Aspect 20. The method of any one of Aspects 13 to 19, further comprising transporting or moving the fluid in an oil or gas pipeline.

Aspect 21. The method of any one of Aspects 13 to 20, wherein the fluid comprises water and one or more hydrocarbons.

Aspect 22. The method of any one of Aspects 13 to 21, wherein the corrosion inhibitor composition is introduced, added, or injected into the fluid continuously, or discontinuously at a frequency from about once per week to about once every three months.

Aspect 23. The method of any one of Aspects 13 to 22, wherein the corrosion inhibitor composition is present in the fluid in an amount of from 5 ppmw to 5,000 ppmw based upon a total weight of the fluid.

Aspect 24. The method of any one of Aspects 13 to 23, wherein the corrosion inhibitor composition is present in the fluid in an amount of from 50,000 ppm to 900,000 ppm based upon a total weight of the fluid.

Aspect 25. The method of any one of Aspects 13 to 24, wherein the fluid comprises water and one or more of crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof.

Aspect 26. The method of any one of Aspects 13 to 25, wherein the corrosion inhibitor composition exhibits an increase in a percentage protection against corrosion of the metal surface in comparison to an otherwise similar corrosion inhibitor composition that does not include the carbon-based nanoparticles.

Aspect 27. A method of inhibiting corrosion on a metal surface of an equipment, comprising: coating the metal surface of the equipment (e.g., a pipe, a pipeline, a heat exchanger, a buffer storage vessel, or a treatment vessel) with the corrosion inhibitor composition of any one of Aspects 1 to 12.

Aspect 28. A container comprising: walls that form the container; and a corrosion inhibitor composition contained in the walls, wherein the corrosion inhibitor composition comprises: carbon-based nanoparticles, one or more corrosion inhibitor compounds, and one or more solvents.

Aspect 29. A tablet comprising: an excipient; and a corrosion inhibitor composition contained in the excipient, wherein the corrosion inhibitor composition comprises: carbon-based nanoparticles, one or more corrosion inhibitor compounds, and one or more solvents, wherein the excipient breaks apart or dissolves in a fluid in which corrosion inhibition is desired.

Aspect 30. A method of inhibiting corrosion on a metal surface of an equipment, comprising: i) adding, introducing, or injecting a container or tablet comprising the corrosion inhibitor composition of any one of Aspects 1 to 12 into a fluid that is or will be in contact with the metal surface, and dissolving the container or excipient of the tablet to activate the corrosion inhibitor composition in the fluid.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A corrosion inhibitor composition comprising:
carbon-based nanoparticles;
one or more corrosion inhibitor compounds; and
one or more solvents.

2. The corrosion inhibitor composition of claim 1, wherein the carbon-based nanoparticles i) are not covalently bonded to a compound in the corrosion inhibitor composition, ii) do not react with any compound in the corrosion inhibitor composition, or both i) and ii).

3. The corrosion inhibitor composition of claim 1, wherein the one or more corrosion inhibitor compounds comprises one or more imidazoline compounds or derivatives thereof, one or more quaternary ammonium compounds, one or more organic sulfur compounds, one or more phosphate esters, one or more monomeric or oligomeric fatty acids, one or more alkoxylated amines, or combinations thereof.

4. The corrosion inhibitor composition of claim 1, wherein the corrosion inhibitor composition from about 1 wt % to about 99 wt % of the one or more corrosion inhibitor compounds.

5. The corrosion inhibitor composition of claim 1, wherein the carbon-based nanoparticles comprise carbon nanotubes, carbon dots, carbon quantum dots, graphene, graphene quantum dots, graphene oxide, or combination thereof.

6. The corrosion inhibitor composition of claim 1, wherein at least one dimension of the carbon-based nanoparticles is in a range of from 1 nm to less than 1,000 nm.

7. The corrosion inhibitor composition of claim 1, having from about 0.1 wt % to about 50 wt % of the carbon-based nanoparticles based on a total weight of the corrosion inhibitor composition.

8. The corrosion inhibitor composition of claim 1, wherein the corrosion inhibitor composition comprises from about 0.1 wt % to about 1 wt % of the carbon-based nanoparticles.

9. The corrosion inhibitor composition of claim 1 8, wherein a weight ratio of the one or more corrosion inhibitor compounds to the carbon-based nanoparticles is in a range of from 10:1 to 500:1.

10. The corrosion inhibitor composition of claim 1, wherein the one or more solvents is selected from water, alcohols, hydrocarbons, ketones, ethers, aromatics, amides, nitriles, sulfoxides, esters, glycol ethers, aqueous systems, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, brine, seawater, glycols, glycol derivatives, ketones, pentane, hexane, cyclohexane, methylcyclohexane, heptane, decane, dodecane, diesel, toluene, xylene, heavy aromatic naphtha, fatty acid derivatives, or combinations thereof.

11. The corrosion inhibitor composition of claim 1, wherein the one or more solvents comprises xylene.

12. The corrosion inhibitor composition of claim 1, further comprising one or more additional components selected from asphaltene inhibitors, paraffin inhibitors, scale inhibitors, emulsifiers, water clarifiers, dispersants, emulsion breakers, hydrogen sulfide scavengers, gas hydrate inhibitors, biocides, pH modifiers, surfactants, functional agents and other additives, or combinations thereof.

13. A method of inhibiting corrosion on a metal surface of an equipment, comprising:
i) contacting a fluid comprising a corrosion inhibitor composition with the metal surface, wherein the corrosion inhibitor composition comprises carbon-based nanoparticles, one or more corrosion inhibitor compounds, and one or more solvents;
ii) adding, introducing, or injecting the corrosion inhibitor composition into a fluid that is or will be in contact with the metal surface; or
iii) both i) and ii).

14. The method of claim 13, wherein the metal surface is a carbon steel, wherein the metal surface is part of equipment used in: a production, transportation, storage, and/or separation of crude oil or natural gas; a coal-fired process; a waste-water process; a farm; a slaughter house; a land-fill; a municipality waste-water plant; a coking coal process; a biofuel process; a cooling water system for a nuclear power plant; a geothermal heating or cooling process; a desalination process; a farm; or a land-fill.

15. The method of claim 13, wherein the fluid comprises water and one or more hydrocarbons selected from crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof.

16. The method of claim 13, further comprising producing the fluid from a wellbore formed in a subterranean formation, transporting the fluid in an oil or gas pipeline, storing, or separating the fluid, prior to said contacting, introducing, adding, or injecting of the corrosion inhibitor composition.

17. The method of claim 13, wherein the corrosion inhibitor composition is contained in a container or a tablet when added, introduced, or injected into the fluid.

18. The method of claim 13, wherein the corrosion inhibitor composition is present in the fluid in an amount of from 5 ppmw to 5,000 ppmw or in an amount of from 50,000 ppmw to 900,000 ppmw based upon a total weight of the fluid.

19. The method of claim 13, wherein the corrosion inhibitor composition exhibits an increase in a percentage protection against corrosion of the metal surface in comparison to an otherwise similar corrosion inhibitor composition that does not include the carbon-based nanoparticles.

20. A method of inhibiting corrosion on a metal surface of an equipment, comprising:
coating a metal surface of a pipe, a pipeline, a heat exchanger, a buffer storage vessel, or a treatment vessel with a corrosion inhibitor composition comprising carbon-based nanoparticles, one or more corrosion inhibitor compounds, and one or more solvents.
